(19) United States
(12) Patent Application Publication
(10) Pub. No.: US 2016/0107351 A1
(43) Pub. Date: Apr. 21, 2016

(54) NON-OBSTRUCTIVE CENTERING LINKAGE MECHANISM FOR STACK MOULD

(71) Applicant: Alexander Segal, Richmond Hill (CA)

(72) Inventor: Alexander Segal, Richmond Hill (CA)

(21) Appl. No.: 14/887,224

(22) Filed: Oct. 19, 2015

Related U.S. Application Data
(60) Provisional application No. 62/065,755, filed on Oct. 19, 2014.

(51) Int. Cl. B29C 45/17; B29C 45/66; B29C 45/32

(52) U.S. Cl. CPC B29C 45/1775; B29C 45/1756; B29C 45/32; B29C 45/66

(57) ABSTRACT

A centering linkage mechanism for a stack mould which provides uninhibited access to the moulding stations. The centering linkage mechanism includes a lever pivotally mounted to a fixed structure, such as a stationary back plate, so as to defining a base joint; a first linkage bar having first and second ends, the first end pivotally connected to a moving platen, and the second end pivotally connected to the lever so as to define a first joint; and a second linkage bar having first and second ends, the first end pivotally connected to a moveable center section of the stack mould, the second end being pivotally connected to the lever so as to define a second joint.

### FIELD

The invention relates generally to the field of injection moulding machines.

### BACKGROUND

Stack moulds are well known in the art. These machines require linkage mechanisms to simultaneously open and close two moulding stations located along the same axis. Examples of such machines and their operating mechanisms can be seen in U.S. Pat. Nos. 5,578,333, 5,707,666, 6,099,784, 6,155,811 and 7,125,247. Such linkage mechanisms, however, generally block external access to the moulding stations making it difficult to automate the entire manufacturing cycle. An improved linkage mechanism is desired.

### SUMMARY OF INVENTION

In an aspect, an injection moulding machine is provided which includes a support structure; a stationary platen with a mould plate, fixed to the support structure; a moveable platen with a mould plate; a primary drive for axially reciprocating the moving platen between an open position and a closed position; at least one moveable center section having first and second mould plates on opposing sides thereof, the first mould plate facing the stationary platen mould plate so as to define a first set of mould cavity spaces when the moveable platen is in the closed position, the second mould plate facing the moving platen mould plate so as to define a second set of mould cavity spaces when the moveable platen is in the closed position; and a centering linkage mechanism for converting the reciprocating movement of the moveable platen to corresponding reciprocating movement of the center section. The centering linkage mechanism includes: a lever pivotally mounted to a fixed structure, such as a stationary back plate, so as to defining a base joint; a first linkage bar having first and second ends, the first end pivotally connected to the moving platen, and the second end pivotally connected to the lever so as to define a first joint; and a second linkage bar having first and second ends, the first end pivotally connected to the center section, and the second end pivotally connected to the lever so as to define a second joint.

The second joint can be located along the lever between the base joint and the first joint.

The second linkage bar can have a first linear section and second linear section with a substantially ninety degree angle therebetween, the first end of the second linkage bar being disposed at a free end of the first linear section and the second end of the second linkage bar being disposed at a free end of the second linear section.

The first linkage bar can be orientated substantially horizontally and positioned along a line proximate to a top side of the carrier section. The first section of the second linkage bar can be orientated substantially horizontally and positioned along a line proximate to a bottom side of the carrier section. In this manner, the centering linkage mechanism does not substantially obstruct side and top access to space between the stationary platen and carrier section and space between the carrier section and moving platen when the moving platen is in the open position.

The center section can include a support bed and bearings for supporting movement of the center section over the support structure.

The machine can also include a second center section having third and fourth mould plates on opposing sides thereof, the third mould plate facing the first carrier section mould plate so as to define a third set of mould cavity spaces when the moveable platen is in the closed position, the fourth mould plate facing the moving platen mould plate so as to define the second set of mould cavity spaces when the moveable platen is in the closed position. A third linkage bar having first and second ends is also included, the first end pivotally connected to the second center section, and the second end pivotally connected at a third joint to the lever.

Preferably, the machine comprises two centering linkage mechanisms disposed on opposite sides of the machine.

### BRIEF DESCRIPTION OF DRAWINGS

The foregoing and other aspects of the invention will be more readily appreciated having reference to the attached drawings wherein:

FIG. 1 is an perspective view of a stack mould injection moulding machine in an open position, according to an embodiment

FIG. 2 is an isometric view of the machine shown in FIG. 1, in a closed position;

FIG. 3 is an isometric view of the machine shown in FIG. 1, in an open position;

FIG. 4 is a side view of the machine shown in FIG. 1, in a closed position

FIG. 5 is a side view of the machine shown in FIG. 1, in an open position;

FIG. 6 is a schematic diagram of an alternative embodiment of a stack mould having three moulding stations.

### DETAILED DESCRIPTION

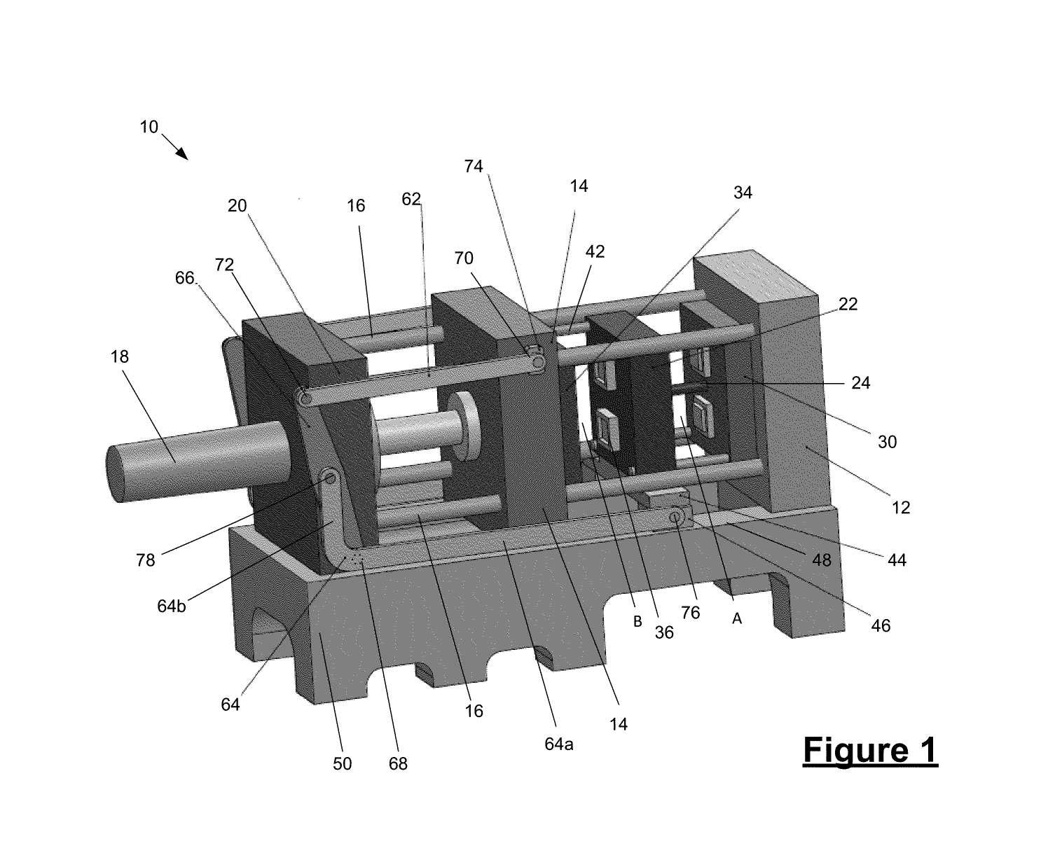

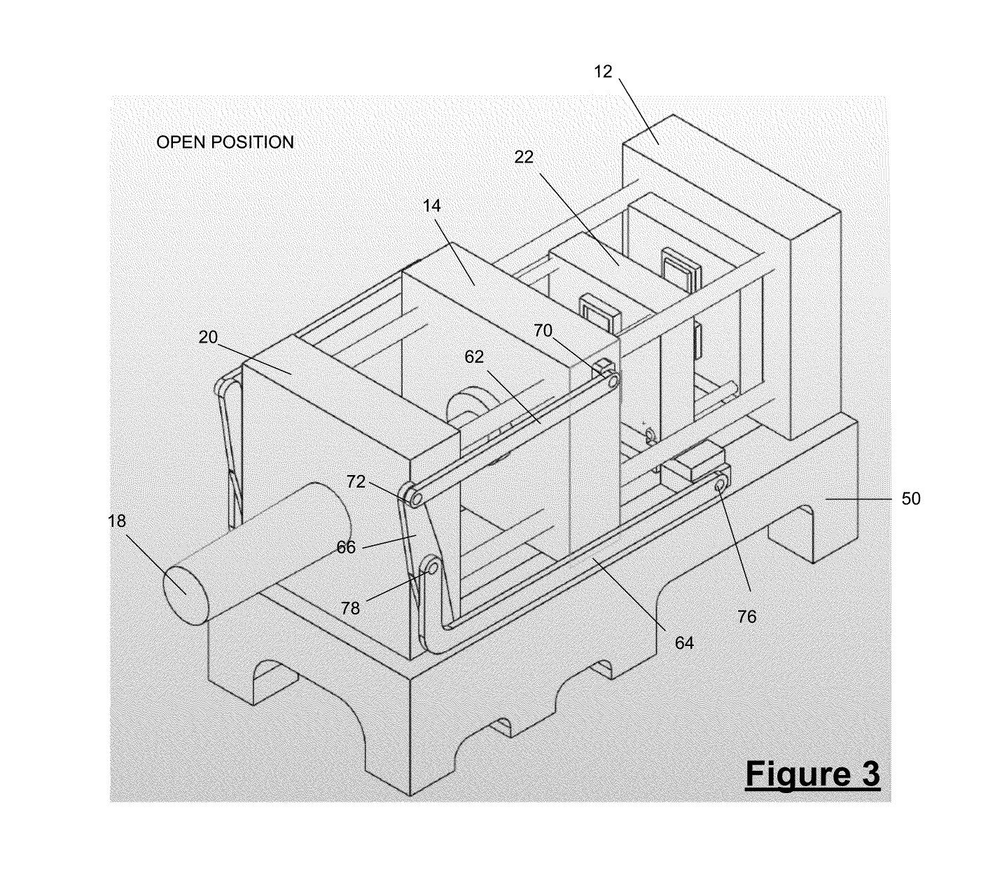

FIGS. 1-5 show an injection moulding machine 10 from various perspectives. Referring to these drawings, and in particular FIG. 1, the machine 10 has a stationary platen 12 and a moving platen 14 which are interconnected via four tie bars 16. The moving platen 14 is reciprocated axially by a primary drive 18, such as a piston/cylinder actuator, which is supported by a stationary machine back plate 20.

For references purposes the stationary platen 12 is designated as the “front” of the moulding machine illustrated herein, the stationary machine back plate 20 is designated as the “rear” of the machine, with two “sides” parallel to the axis of the translation. Of course, these are terms of reference only.

The moulding machine 10 includes a moveable center section 22 which functions as the mould hot runner. A sprue bar 24 delivers molten material to the center section 22.

Being a stack mould, the machine 10 has two moulding stations A and B. Station A is provided by a mould plate 30 mounted on the stationary platen 24 and a mould plate mounted 32 mounted on the immediately adjacent side of the center section 22. When juxtaposed or closed together these two mould plates 30, 32 define a first set of mould cavity spaces into which molten material is injected. Likewise, Station B is provided by a mould plate 34 mounted on the moving platen 14 and a mould plate 36 mounted on the immediately adjacent side of the center section 22. When juxtaposed or closed together these two mould plates 34, 36 define a second set of mould cavity spaces into which molten material is injected.

It will be understood from the foregoing that as the moving platen 14 reciprocates between open and closed positions to open and close the mould, the center section 22 must also move relative to the stationary and moving platens 12, 14 in order to open the stations A and B for ejection or removal of the moulded articles. In particular, in a balanced or symmetrical mould the center section 22 moves half the distance or half the stroke of the moving platen 14, relative to the stationary platen 12, so the opening width of stations A and B are equal. In some circumstances, for example, where stations A and B mould articles of different sizes, it may be desirable for the center section 22 to have a different stroke ratio so that the opening widths of stations A and B are different.

The moveable center section 22 is guided by leader pins 40 extending from the stationary platen 12 and leader pins 42 extending from the moving platen 14. The center section 22 is supported by a central mould support bed 44 that seats on two linear bearings 46 which ride on rails 48 of a support structure 50. The central mould support bed 44 and linear bearings 46 are structurally fixed to the main body of the center section 22 and thus can be considered as part of the center section.

A novel centering linkage mechanism 60 interconnects the center section 22 with the moving platen 14 so that movement of the moving platen 14 is translated into movement of the center section 22 at a predetermined stroke ratio. The linkage mechanism 60 includes a top linkage bar 62, a bottom linkage bar 64, and a lever 66 interconnecting the top and bottom linkage bars 62, 64. The top linkage bar 62 is, advantageously, disposed along the top side of the moulding machine, preferably (but not necessarily) substantially parallel to the tie bars 16. The bottom linkage bar 64 is, advantageously, disposed below the center section 22 proximate and parallel to the rails 48. This arrangement leaves unfettered top and side access to the mould stations A and B.

The lever 66 is pivotally connected to a side wall of the stationary machine back plate 20 via a base pivot joint 68 located near the bottom of the side wall proximate to the support structure 50.

The top linkage bar 62 is preferably a straight bar that is pivotally connected to the moving platen 14 via a moving platen joint 70 and is pivotally connected to a top portion of the lever 66 via a top arm joint 72. These joints may be provided by post and hole formations in the connecting structures. A linkage bearing plate 74 can be affixed to the side wall of the moving platen 14 to support the movement of the top linkage bar 62.

The bottom linkage bar 64 has a long straight substantially horizontal section 64a and a shorter substantially straight vertical section 64b, with preferably a substantially ninety degree angle between the horizontal and vertical sections 64a, 64b. The front end of the bottom linkage bar 64 is pivotally connected to the center section 22 via a center section joint 76 at the linear bearing 46.

In alternative embodiments the front end of the horizontal section 64a can be pivotally connected to the central mould support bed 44 or to the main body of the center section 22, although these are not the most preferred arrangements because they reduce side access to the moulding stations A, B.

The rear end of the bottom linkage bar 64 is pivotally connected to the lever 66 via a middle arm joint 78.

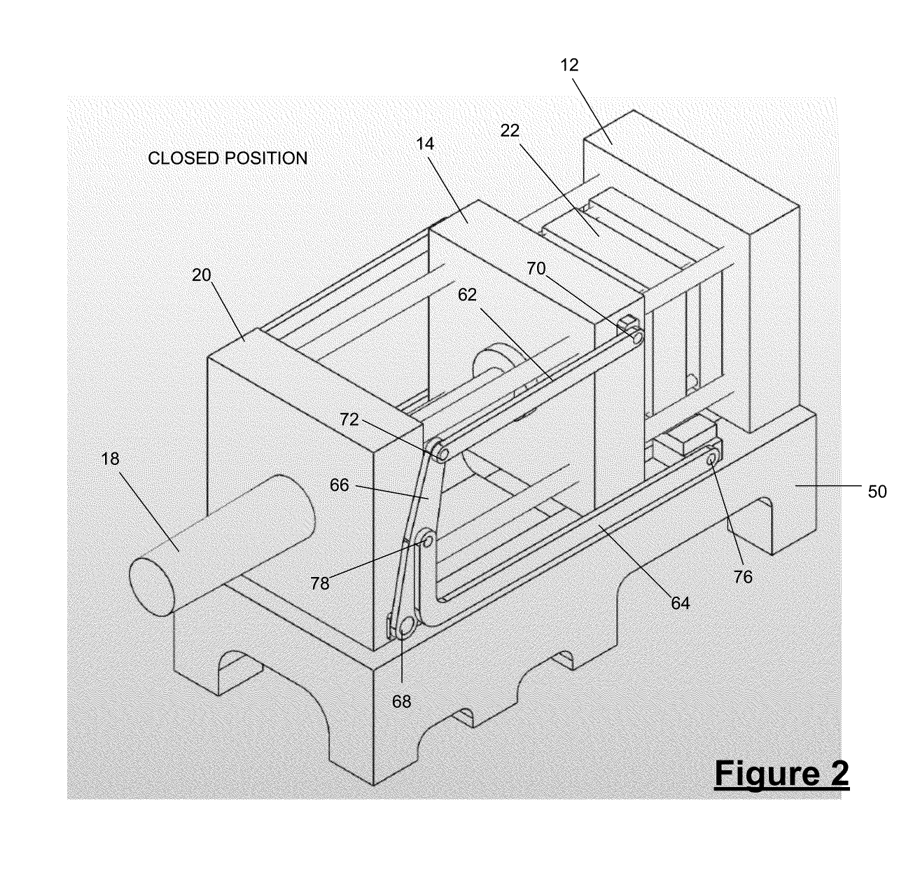

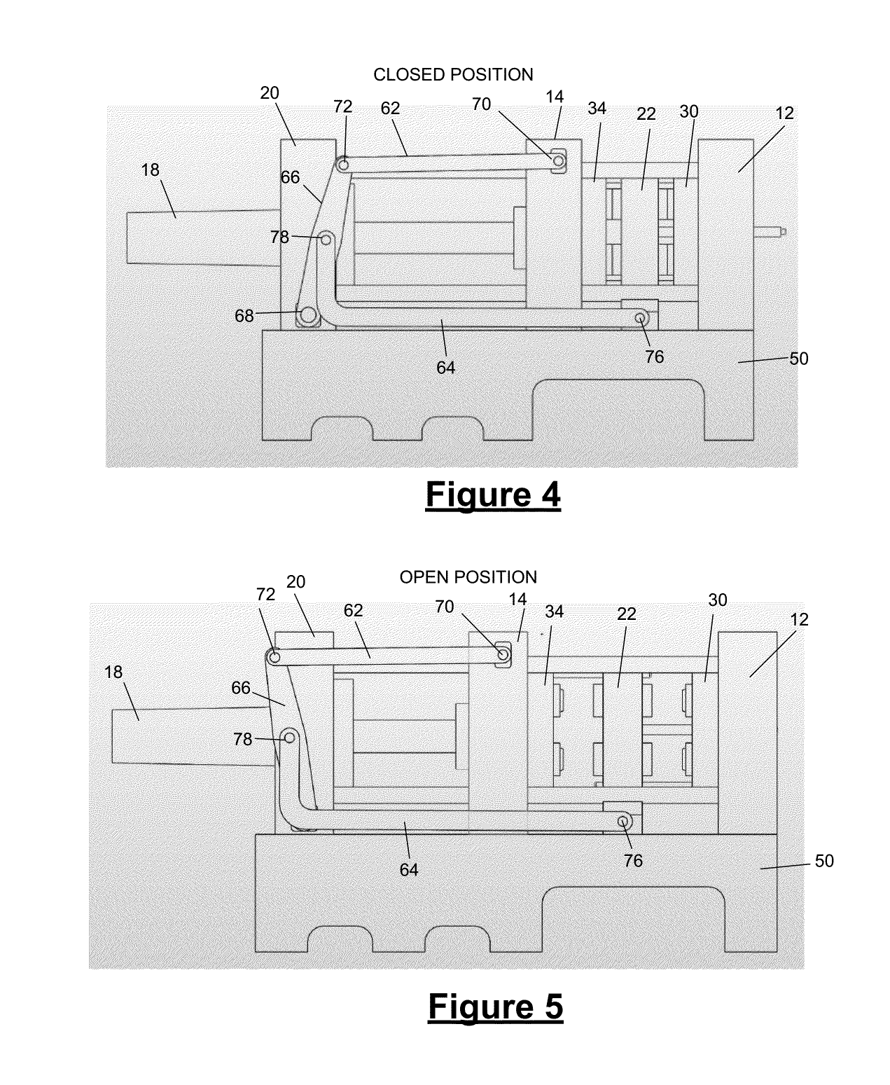

In operation, the primary drive 18 reciprocates the moving platen 14 between open (FIGS. 1, 3 and 5) and closed (FIGS. 2 and 4) positions. As the moving platen 14 is connected to the lever 66 via the top linkage bar 62, the lever 66 will pivot over an operating angle about the base pivot joint 68. The bottom linkage bar 64, being pivotally connected to the lever 66 above the base pivot joint 68, will thus also reciprocate in tandem with the top linkage bar 62, reciprocating the moveable center section 22 between its open and closed positions. The position of the middle arm joint 78 relative to the top arm joint 72 defines the stroke of the center section 22 relative to the stroke of the moving platen 14.

For example, the middle arm joint 78 can be positioned halfway between the top arm joint 72 and the base joint 68, whereby the stroke of the moveable center section is half the stroke of the moving platen. This will place the moveable center section 22 in the middle between the stationary and moving platens 12, 14 so that the openings to moulding stations A and B are equally sized. A higher-positioned middle arm joint 78 will generate a larger stroke of the moveable center section 22, increasing the opening to moulding station A, whereas a lower-positioned middle arm joint will generate a smaller stroke of the moveable center section 22, increasing the opening to moulding station B.

In operation, the top and bottom linkage bars 62, 64 may shift somewhat in horizontal attitude due the arcuate travel paths of the top arm and middle arm joints 72, 78. To minimize this, the linkage mechanism 60 can be configured such that the lever arm 66 reaches a vertical position in the middle of its operating range. Alternatively, if desired, the pivot holes in these joints may be slightly elongated to provide some lost motion to avoid this phenomenon but this may be otherwise omitted as the pivoting connections between the linkage bars 62, 64 and the axially restrained mould sections limit weight transfer to their bearings and/or lever.

In practice the moulding machine 10 will typically employ two centering linkage mechanisms 60, one on each side of the moulding machine as illustrated, in order to balance moving forces and avoid skew.

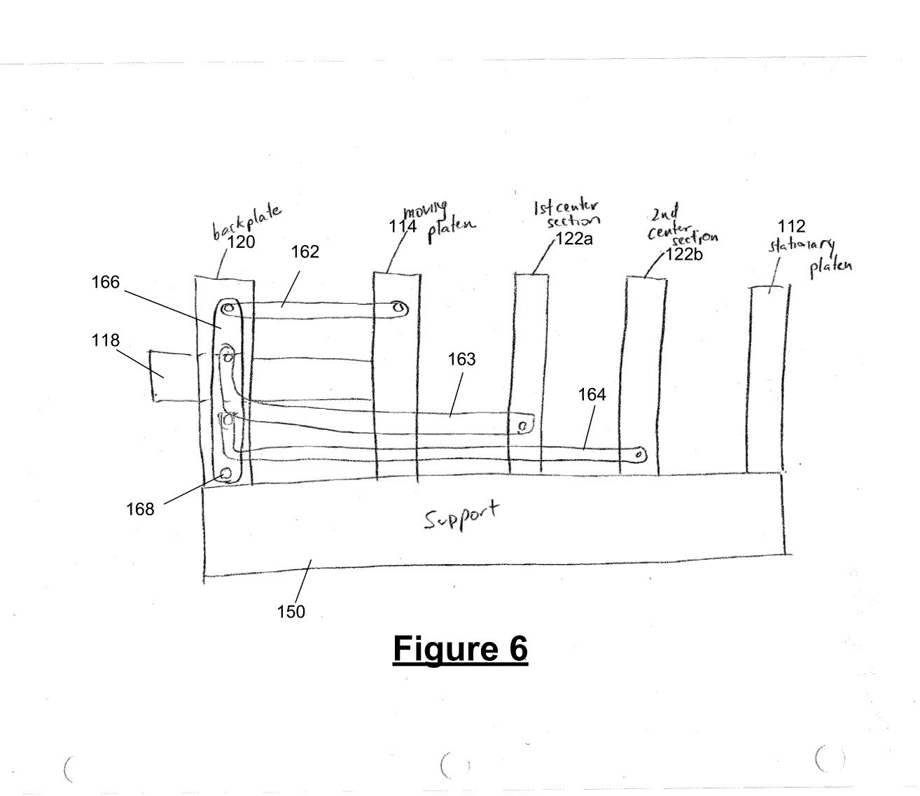

The linkage mechanism may also be adapted to move plural central mould sections by pivotally connecting additional linkage bars to the lever at suitable locations. This is schematically illustrated in FIG. 6 for a double center section stack mould 110 having three moulding stations A, B, and C. This machine 110 has a stationary platen 112, a back plate 120, a moving platen 114 driven by a primary drive 118, a 1st center section 122a, and a second center section 122b. A lever 166 is pivotally connected to the back plate 120 at a base joint 168. A top linkage bar 162 is pivotally connected at its front and rear ends to the moving platen 114 and the lever 166, respectively. A middle linkage bar 163 is pivotally connected at its front and rear ends to the 1st center section 122a and the lever 166, respectively. A bottom linkage bar 164 is pivotally connected at its front and rear ends to the 2nd center section 122b and the lever 166, respectively. The relative distances between the joints on the lever 166 dictate the respective opening distances of the moulding stations A, B and C.

The base pivot joint 68 of machine 10 has been shown located at the base of the stationary back plate 20, but it will be appreciated that this joint 68 could be located at another fixed structure such as the support structure 50, which may be beneficial to increase the length of the lever 66 and reduce the lever operating angle.

Those skilled in the art will appreciate that a variety of other alternations or modifications may be made to the embodiments discussed herein without departing from the spirit of the invention.

I claim:

1. An injection moulding machine, comprising:
a support structure;
a stationary platen with a mould plate, fixed to the support structure;
a moveable platen with a mould plate;
a primary drive for axially reciprocating the moving platen between an open position and a closed position;
at least one moveable center section having first and second mould plates on opposing sides thereof, the first mould plate facing the stationary platen mould plate so as to define a first set of mould cavity spaces when the moveable platen is in the closed position, the second mould plate facing the moving platen mould plate so as to define a second set of mould cavity spaces when the moveable platen is in the closed position;
a centering linkage mechanism for converting the reciprocating movement of the moveable platen to corresponding reciprocating movement of the center section;
characterized in that the centering linkage mechanism includes:
a lever pivotally mounted to a fixed structure, such as a stationary back plate, so as to defining a base joint;
a first linkage bar having first and second ends, the first end pivotally connected to the moving platen, and the second end pivotally connected to the lever so as to define a first joint;
a second linkage bar having first and second ends, the first end pivotally connected to the center section, and the second end pivotally connected to the lever so as to define a second joint.

2. An injection moulding machine according to claim 1, wherein the second joint is located along the lever between the base joint and the first joint.

3. An injection moulding machine according to claim 1, wherein the second linkage bar has a first linear section and second linear section with a substantially ninety degree angle therebetween, the first end of the second linkage bar being disposed at a free end of the first linear section and the second end of the second linkage bar being disposed at a free end of the second linear section.

4. An injection moulding machine according to claim 3, wherein:
the first linkage bar is orientated substantially horizontally and positioned along a line proximate to a top side of the carrier section; and
the first section of the second linkage bar is orientated substantially horizontally and positioned along a line proximate to a bottom side of the carrier section;
whereby the centering linkage mechanism does not substantially obstruct side and top access to space between the stationary platen and carrier section and space between the carrier section and moving platen when the moving platen is in the open position.

5. An injection moulding machine according to claim 1, wherein the center section includes a support bed and bearings for supporting movement of the center section over the support structure.

6. An injection moulding machine according to claim 1, including:
a second center section having third and fourth mould plates on opposing sides thereof, the third mould plate facing the first carrier section mould plate so as to define a third set of mould cavity spaces when the moveable platen is in the closed position, the fourth mould plate facing the moving platen mould plate so as to define the second set of mould cavity spaces when the moveable platen is in the closed position;
a third linkage bar having first and second ends, the first end pivotally connected to the second center section, and the second end pivotally connected at a third joint to the lever.

7. An injection moulding machine according to claim 6, wherein the third joint is located along the lever between the base joint and the first joint.

8. An injection moulding machine according to claim 7, wherein the second center section includes a support bed and bearings for supporting movement of the second center section over the support structure.

9. An injection moulding machine according to claim 1 comprising two centering linkage mechanisms disposed on opposite sides of the machine.

10. An injection moulding machine according to claim 2, wherein the second linkage bar has a first linear section and second linear section with a substantially ninety degree angle therebetween, the first end of the second linkage bar being disposed at a free end of the first linear section and the second end of the second linkage bar being disposed at a free end of the second linear section.
